(19) United States
(12) Patent Application Publication
(10) Pub. No.: US 2024/0122268 A1
(43) Pub. Date: Apr. 18, 2024

(54) Aerosol Generation Device with Light Emitting Indicator

(71) Applicant: JT International SA, Geneva (CH)

(72) Inventor: Akira Yamaguchi, Geneva (CH)

(73) Assignee: JT International SA, Geneva (CH)

(21) Appl. No.: 18/277,493

(22) PCT Filed: Jan. 28, 2022
(86) PCT No.: PCT/EP2022/052108

§ 371 Date: Aug. 16, 2023

(30) Foreign Application Priority Data
Feb. 22, 2021 (EP) 21158416.4

(51) Int. Cl. A24F 40/60; A24F 40/40; F21V 3/06

(52) U.S. Cl. CPC A24F 40/60; A24F 40/40; F21V 3/062; F21Y 2115/10

(57) ABSTRACT

An aerosol generation device includes a cover, a light-emitting indicator, and a main body with a main housing forming the exterior surface of the main body configured for generating an aerosol from an aerosol generation substrate and including the light-emitting indicator. The cover is releasably attached or connected to the main housing to cover a portion of the exterior surface and to form part of the exterior surface of the aerosol generation device, and includes a light-transmissive portion. The light-emitting indicator is configured to emit light through the light-transmissive portion in a light propagation direction. The projection of the light-emitting indicator onto a plane which is transversal to the light propagation direction has a first shape and size, and the projection of the light-transmissive portion onto this plane has a second shape and size, the second size is smaller than the first size and fully fits into the first shape.

### FIELD OF INVENTION

The present invention relates to an aerosol generation device, in particular an aerosol generation device comprising a cover and a light-emitting indicator.

### TECHNICAL BACKGROUND

Aerosol generation devices commonly found on the marked typically comprise a light-emitting indicator for indicating information pertaining the aerosol generation device and its operation to a user. The light-emitting indicator is typically accommodated inside a device housing of the aerosol generation device for protection against harmful external influences such as wear and tear. The device housing is typically provided with a light-guide, viewing window or similar light-transmissive part to render the light-emitting indicator visible to a user.

However, due to manufacturing and assembly tolerances, misalignment between the relative arrangement of the light-emitting indicator and the light-transmissive portion can cause the light-emitting indicator to illuminate only a portion of the light-transmissive portion, or to illuminate the light-transmissive portion in an inhomogeneous manner.

Therefore, there is a need for an aerosol generation device that consistently affords a more homogeneous illumination provided by a light-emitting indicator.

### SUMMARY OF THE INVENTION

Some, or all of the above objectives are achieved by the invention as defined by the features of the independent claims. Preferred embodiments of the invention are defined by the features of the dependent claims.

A first aspect of the invention is an aerosol generation device comprising a main body with a main housing that forms the exterior surface of the main body, the main body being configured for generating an aerosol from an aerosol generation substrate and comprising a light-emitting indicator. The aerosol generation device further comprises a cover that is releasably attached or connected to the main housing to cover a portion of the exterior surface of the main housing and to form part of the exterior surface of the aerosol generation device, the cover comprising a light-transmissive portion. The light-emitting indicator is configured to emit light through the light-transmissive portion in a light propagation direction through the light-transmissive portion. The projection of the light-emitting indicator onto a plane which is transversal to the light propagation direction has a first shape and size, and the projection of the light-transmissive portion onto this plane has a second shape and size, and the second size is smaller than the first size and the second shape fully fits into the first shape.

The second size being smaller than the first size allows that the entire light-transmissive portion can be reliably and sufficiently illuminated to achieve a more homogeneous illumination of the light-transmissive portion. It allows for a certain extent of misalignment between the arrangement of the light-transmissive portion and the light-emitting indicator that may be caused by manufacturing tolerances. In case of misalignment, due to the light-emitting indicator having a larger size in the plane transversal to light propagation that light-transmissive portion, if the misalignment is within a certain extent, the light-transmissive portion will remain more homogeneously illuminated. Additionally, since the cover that comprises the light-transmissive portion is releasable from the main body, replacing or repairing the light-transmissive portion and/or the light-emitting indicator is facilitated in case of misalignment.

According to a 2^{nd} aspect, in the first aspect, the light-emitting indicator is a light source. Since a light source is configured to directly emit light through the light-transmissive portion and thus illuminate the light-transmissive portion, the illumination configuration is simplified and more compact.

The 2^{nd} aspect is advantageous because it minimizes the requirement of additional components such as light-diffusing or light-guiding components in order to fully illuminate the light-transmissive portion as may be the case if the light source is at least partially covered or obscured such that light source cannot or only partially emit light directly through the light-transmissive portion.

According to a 3^{rd} aspect, in the preceding aspect, the light source comprises or substantially consists of a plurality of individual LED light sources or an LED strip. The 3^{rd} aspect is advantageous as individual LED light sources or an LED light strip are energy efficient, produce little heat, and are compact in size. This allows the overall footprint of the aerosol generation device to be reduced.

According to a 4^{th} aspect, in any one of the preceding aspects, the light-emitting indicator and the light-transmissive portion are aligned relative to each other such that light emitted from the light-emitting indicator in the light propagation direction illuminates substantially the entire light-transmissive portion.

The 4^{th} aspect is advantageous is advantageous because it further reduces the need for additional components such as light-diffusing or light-guiding components in order to fully illuminate the light-transmissive portion.

According to a 5^{th} aspect, in any one of the preceding aspects, the light propagation direction is substantially perpendicular to the exterior surface of the light-transmissive portion.

According to a 6^{th} aspect, in anyone of the preceding aspects, the light-emitting indicator has an elongated shape with a length that corresponds to the extension of the light-emitting indicator in the elongation direction, and a width that corresponds to the extension of the light-emitting indicator in the direction perpendicular to the elongation direction, and perpendicular to the light propagation direction.

According to a 7^{th} aspect, in the preceding aspect, the light-transmissive portion has a length which is smaller than the length of the light-emitting indicator, and a width which is smaller than the width of the light-emitting indicator.

According to an 8^{th} aspect, in the preceding aspect, the first shape and the second shape are geometrically similar such that they can be made congruent through uniform scaling.

The 5^{th}, 6^{th}, 7^{th} and 8^{th} aspect are respectively advantageous because they reduce the required second size of the light-emitting indicator without changing the allowed misalignment between the light-emitting indicator and the light-transmissive portion for achieving a more homogeneous illumination of the light-transmissive portion.

According to a 9^{th} aspect, in any one of the preceding aspects, a portion or all of the cover surrounding or encircling the light-transmissive portion is opaque.

The 9^{th} aspect is advantageous because it enhances the illumination effect of the light-transmissive portion and hence increases the homogeneity of the illumination.

According to a 10^{th} aspect, in any one of the preceding aspects, the cover comprises or substantially consists of a composite laminar structure comprising a plurality of layers, each layer having an outer surface facing towards the outside of the aerosol generation device, and an inner surface facing towards the main housing.

The 10^{th} aspect is advantageous because a composite laminar structure allows the cover to be provided with a wide range of different mechanical and optical properties based on the number and the type of layers comprised.

According to an 11^{th} aspect, in the preceding aspect, the plurality of layers comprises a light-transmissive plastic film layer.

According to a 12^{th} aspect, in the preceding aspect, the light-transmissive portion comprises at least a portion of the light-transmissive plastic film layer.

The 11^{th} and 12^{th} aspects are advantageous because they respectively allow a portion or the entirety of the light-transmissive portion and a portion or the entirety of the cover to be integrally formed by using a composite laminar structure.

According to 13^{th} aspect, in any one of the 11^{th} to 12^{th} aspects, the light-transmissive plastic film is provided on its inner surface with one or more at least partially or fully opaque layers.

The 13^{th} aspect is advantageous because it allows a portion or the entirety of the cover to be opaque while allowing for the cover to be provided with a wide range of mechanical and optical properties based on the provided layers.

According to a 14^{th} aspect, in the preceding aspect, the light-transmissive portion comprises a number of partially opaque layers that is less than the number of at least partially or fully opaque layers comprised by portions of the cover that are opaque.

The 14^{th} aspect is advantageous because it allows the light-transmissive characteristics of the light-transmissive portion to be adapted while allowing for the light-transmissive portion to be provided with a wide range of mechanical and optical properties based on the provided layers.

According to a 15^{th} aspect, in any one of the 13^{th} to 14^{th} aspects, the light-transmissive portion does not comprise a partially opaque layer.

The 15^{th} aspect is advantageous because it allows the light-transmissive properties of the light-transmissive portion to be defined by light-transmissive layer comprised by the composite laminar structure of the cover. At the same time, portions of the cover other than the light-transmissive portion can be rendered at least partially or fully opaque using the same composite laminar structure of the cover.

According to a 16^{th} aspect, in any one of the 13^{th} to 15^{th} aspects, the one or more at least partially or fully opaque layers are interposed between the light-transmissive plastic film and a support layer.

The 16^{th} aspect is advantageous it provides a cover that is durable and simple to manufacture. Mechanical and optical properties can be adapted, and set based on the layers comprised in the composite laminar structure of the cover, while the light-transmissive plastic film provides protection against outside influences and the support layer provides mechanical strength and support.

According to a 17^{th} aspect, in any one of the 13^{th} to 16^{th} aspects, the one or more at least partially or fully opaque layers comprise or consist of one or more printed layers.

The 17^{th} aspect is advantageous because the at least partially or fully opaque layers can be cost-efficiently achieved via any suitable printing method and be provided with a wide range of visual appearances.

According to an 18^{th} aspect, in any one of the preceding claims, the cover is film insert molded (FIM).

The 18^{th} aspect is advantageous because it affords a cover that is cost-efficient and flexible to manufacture.

According to a 19^{th} aspect, in any one of the preceding aspects, the cover is releasably attached to the main housing via one or more magnetic coupling elements provided with the cover that interact with one or more respective magnetic counter-coupling elements provided with the main housing.

The 19^{th} aspect is advantageous because it provides a means of attaching and detaching the cover from the main body that is reliable, convenient, and free of mechanical wear and tear.

According to a 20^{th} aspect, in any one of the preceding aspect, the aerosol generation device is an electronic cigarette.

### BRIEF DESCRIPTION OF THE DRAWINGS

FIGS. 1A and 1B respectively show schematic illustrations of a side-view and a top-view of an aerosol generation device, according to embodiments of the invention;

FIGS. 2A, 2B and 2C respectively show schematic illustrations of a top view of an aerosol generation device, a top view of a main housing of the aerosol generation, and a bottom view of a cover of the aerosol generation device, according to embodiments of the invention;

FIGS. 3A and 3B respectively illustrate partial cross-sections of a cover according to embodiments of the invention.

### DETAILED DESCRIPTION OF PREFERRED EMBODIMENTS

Preferred embodiments of invention are described hereinafter and in conjunction with the accompanying drawings.

In the following detailed description of the present invention, it should be understood that the terms “one end”, “the other end”, “outer side”, “upper”, “above”, “inner side”, “under”, “below”, “horizontal”, “coaxial”, “central”, “end” “part”, “length”, “outer end” etc., which indicate the orientation or positional relationship, are based on the orientation or positional relationship shown in the drawings. The terms such as “upper”, “above”, “below”, “under” and the like used in the present invention to indicate a relative position in space are used for the purpose of facilitating explanation to describe a unit or feature shown in the drawings relative to the relationship of another unit or feature. The term of the relative position in space may be intended to include different orientations of the device in use or operation other than those shown in the figures. For example, if the device in the figure is turned over, the unit described as being “below” or “under” other units or features will be “above” the other units or features. Therefore, the exemplary term “below” can encompass both the above and below orientations. The device can be oriented in other ways (rotated by 90 degrees or other orientations), and the space-related descriptors used herein are explained accordingly. More specifically, the word “above” means that one unit, layer or element is arranged or configured relatively in an exterior direction of the device towards the (an)other unit(s), layer(s) or element(s); the word “below” means that one unit, layer or element is arranged or configured relatively in an interior direction of the device towards the other units, layers or elements.

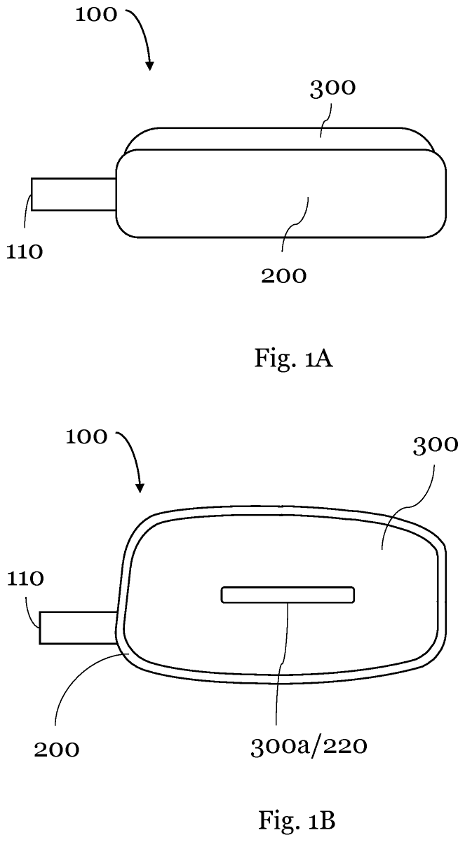

FIGS. 1A and 1B respectively show a side-view and a top-view of an aerosol generation device 100 arranged in a horizontal orientation. The aerosol generation device 100 comprises a main body 200 with a main housing and a cover 300 that is releasably attached to the main housing of the main body 200. The main body 200 is configured to accommodate an aerosol generation unit for generating an aerosol for consumption by a user. The aerosol generation device 100 typically comprises an aerosol generation unit for heating and/or receiving a consumable 110 comprising an aerosol generation substrate. The aerosol generation device 100 may be an electronic cigarette and may be configured to generate an aerosol from an e-vapor or t-vapor substrate. For example, the heating unit may comprise a receptacle configured for receiving a tobacco stick or similar consumable 110, and a heating element may be configured for heating the receptable and the tobacco stick received in the receptacle. Alternatively, the receptable may be configured for receiving a cartridge containing an aerosol generation substrate such as a liquid, and the heating unit may comprise a wicking element or the like and a heating element configured for heating the wicking element.

The aerosol generation device 100 may also comprise a power supply that may be a replaceable and/or rechargeable power supply, and may additionally be provided with a USB port or similar interface functioning as a charging port for charging the rechargeable power supply or a data transmission line, and circuitry. The circuitry may comprise a processing unit and/or a memory unit.

The main housing of the main body 200 substantially encloses internal components of the aerosol generation device 100. Substantially enclosing means enclosing with the exception of openings required for operation of the aerosol generation device 100, such as, for example, a charging port, an air in-/outlets, and an opening for receiving or docking to the consumable 110.

The cover 300 is arranged above the main body 200 and detachable from the main housing. The cover 300 being detachable means that the cover 300 is detachable from the main housing by a user of the aerosol generation device 100 without requiring any additional tools or aids, but by the user utilizing one or both hands.

The aerosol generation device 100 may have an elongated shape to improve the comfort of a user when holding the aerosol generation device 100. The longitudinal direction of the aerosol generation device 100 is the direction in which the aerosol generation device 100 is elongated. In the embodiment shown in FIGS. 1A and 1B, the longitudinal direction of the aerosol generation device 100 corresponds to a horizontal direction. When viewed from above as shown in FIG. 1B, the cover 300 may preferably have a shape corresponding to the shape of the main housing of the main body 200 to contribute to a seamless transition from the main housing of the main body 200 to the cover 300. In a preferred embodiment, the cover 300 is attached to the main housing of the main body 200 via magnetic means.

The cover 300 is provided with a light-transmissive portion 300a that allows light emitted from a light emitting indicator 220 arranged at the surface of the main housing of the main body 200 and underneath the cover 300 to transmitted to the outside of the aerosol generation device 100. In this way, the light emitting indicator 220 is configured to indicate information on the aerosol generation device 100, in particular information on an operational state of the aerosol generation device 100 to a user.

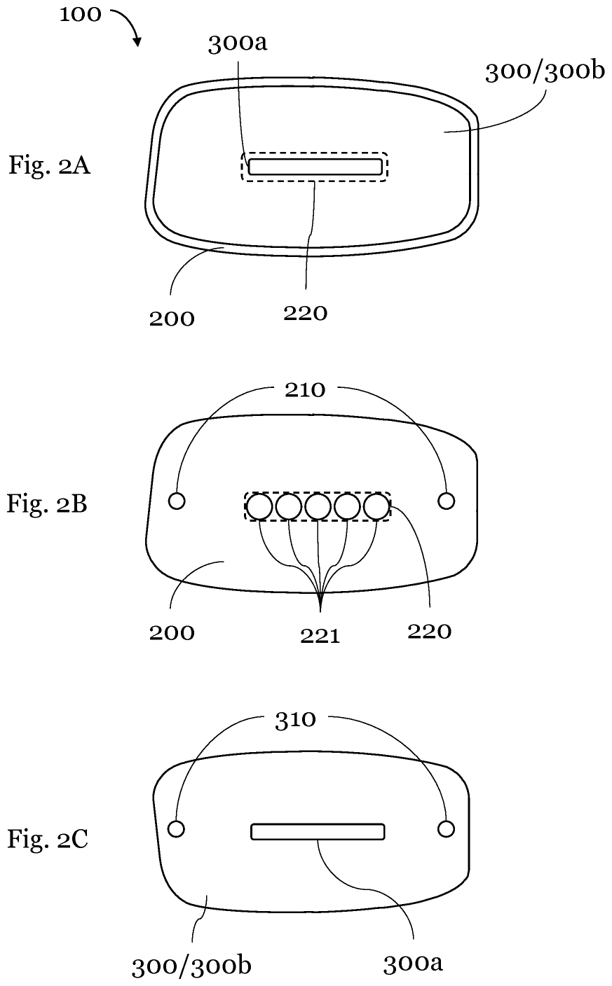

As shown in FIG. 2A, a light-transmissive portion 300a is provided at a removable cover 300 and a light emitting indicator 220 is provided at the surface of the main housing of the main body 200. This is advantageous because it simplifies maintenance and potential repairs on the light-transmissive portion 300a or the light emitting indicator 220 if required. If the light emitting indicator 220 or light-transmissive portion 300a is damaged or requires maintenance, the cover 300 can be detached from the main body 200, and it becomes simple and convenient to access the light emitting indicator 220 or light-transmissive portion 300a. For example, in case the light-transmissive portion 300a is defective, instead of removing the light-transmissive portion 300a from the cover 300, the entire cover 300 may simply be exchanged. The light-transmissive portion 300a forms part of the exterior surface of the cover 300 visible to the outside of the aerosol generation device 100 when attached to the main housing of the main body 200. The exterior surface of the light-transmissive portion 300a is preferably arranged to be flush with the surrounding exterior surface of the cover 300 such that the cover 300 has a smooth exterior surface. Alternatively, the exterior surface of the light-transmissive portion 300a may be arranged slightly recessed or protruding from exterior surface portions of the cover 300.

The light-transmissive portion 300a of the cover 300 and the light emitting indicator 220 provided at a portion of the main housing of the main body 200 that is covered by the cover 300 are preferably arranged such that light emitted from the light emitting indicator 220 is directly transmitted through the light-transmissive portion 300a. That is the case if there is a direct line of sight direction from the outside of the aerosol generation device 100 through the light-transmissive portion 300a to the light emitting indicator 220. In such a configuration, additional components such as a light guide to guide light emitted from the light emitting indicator 220 towards the light-transmissive portion 300a is not required. Furthermore, the projection of the light-emitting indicator onto a plane transversal to a light propagation direction of emitted light through the light-transmissive portion 300a has shape and size that are larger than the shape and size of the projection of the light-transmissive portion onto this transversal plane. In other words, the light emitting indicator 220 is positioned and sized relative to the position and size of the light-transmissive portion 300a such that, when viewed from the outside through the light-transmissive portion 300a in the light propagation direction, the outer boundaries of the light emitting indicator 220 are not visible in the light propagation direction. This has the effect that, when viewing the light emitting indicator 220 through the light-transmissive portion 300a in the light propagation direction, the entire light-transmissive portion 300a is more fully and homogeneously illuminated by the light emitting indicator 220, and spots or regions that are not illuminated by the light emitting indicator 220 are minimized or eliminated. As a consequence, a more homogeneous illumination of the light-transmissive portion 300a can be achieved. To increase the homogeneity of the illumination, the light-transmissive portion 300a portion may be configured to be translucent to provide a certain degree of light diffusion. Due to the shape and size of the light emitting indicator 220 being larger than the shape and size of the light-transmissive portion 300a, it allows for a certain degree of misalignment between the light emitting indicator 220 and the light-transmissive portion 300a without negatively impacting the illumination quality that can be achieved.

Since aerosol generation devices are typically of an elongated shape, the light emitting indicator 220 having an elongated shape, preferably a rectangular shape, with a certain length and a certain width may be particularly preferable because it optimizes use of the exterior surface of the aerosol generation device 100. It should be noted that the length of the light emitting indicator 220 corresponds to the extension of the light emitting indicator 220 in the elongation direction along the outer surface main housing of the main body 200, and the width of the light emitting indicator 220 corresponds to the extension of the light emitting indicator 220 in the direction perpendicular to the length and along the outer surface of the main housing. The light-transmissive portion 300a is thus provided with an elongated shape that corresponds to or correlates with the elongated shape of the light emitting indicator 220, but that is smaller than the shape and the size of the light emitting indicator 220 when viewed from a light propagation direction. While an elongated shape is shown for the light emitting indicator 220 and light-transmissive portion 300a, it should be noted that any suitable shape such as a circular, elliptical, ring-like, polygonal, or otherwise irregular shape may be provided. For example, if the light-transmissive portion 300a is provided with a circular shape with a certain radius, the light emitting indicator 220 is also provided with a circular shape with a certain radius, the radius of the circular shape of the light emitting indicator 220 being larger than the radius of the circular shape of the light-transmissive portion 300a. It may be preferable to provide the light emitting indicator 220 and the light-transmissive portion 300a with a respective shape and size such that they are geometrically similar, i.e. that the shape and size of the light-transmissive portion 300a can be made to match the shape and size of the light emitting indicator 220 by uniformly scaling up the shape and size of the light-transmissive portion 300a.

It should further be noted that a light propagation direction through the light-transmissive portion 300a refers to propagation direction of light through the light-transmissive portion 300a that is substantially perpendicular to the outer surface of the light-transmissive portion 300a. The cover 300 may have a central portion that is substantially planar, and one or more peripheral or circumferential portions that are curved or bent to allow the cover 300 to be adjoined to the main housing of the main body 200. Alternatively, the cover 300 may have a continuously curved shape with a central portion having a curvature that is smaller than the curvature of one or more peripheral or circumferential portions. The light-transmissive portion 300a may be provided as part of the substantially planar portion and/or as part of a curved or bent portion of the cover 300. Thus, the outer surface of the light-transmissive portion 300a may have a planar portion and/or a curved portion. In case of a planar portion of the outer surface of the light-transmissive portion 300a, there exists a single light-propagation direction. In case of a curved portion of the outer surface of the light-transmissive portion 300a, there exists a plurality of light propagation directions, the plurality of light propagation directions forming a solid angle that is based on the curvature of the light-transmissive portion 300a. In case of a curved outer surface of the light-transmissive portion 300a, the solid angle formed by the plurality of light propagation directions perpendicular to the curved outer surface may be further limited based on the type of light emitting indicator 220. The light emitting indicator 220 is preferably a light source, and as shown in FIG. 2B, the light emitting indicator 220 may comprise or substantially consists of a plurality of individual light sources 221 that form a contiguous light emitting element. Alternatively, the light emitting indicator 220 may comprise or substantially consist of a light strip. Individual light source 221 of the light strip may preferably be individual LED light sources or an LED light strip due to their compact size and energy efficiency, although in general any type of incandescent or luminescent light source may be employed. Thus, depending on the type of light source, the beam angle of the light source may vary. While a traditional incandescent light source such as a light bulb may be a very large beam angle, compact surface mounted devices (SMD) such as SMD-LEDS that are preferably due to their compact size emit light substantially only in a direction perpendicular to the surface on which they are mounted. In such a case, the limited beam angle of SMD-LEDs further limits the amount of light propagation directions to a substantially single light propagation direction.

The cover 300 may be releasably attached the main housing of the main body 200 via any suitable means. Such means may comprise mechanical means such as a press-fit connection, a snap-fit connection, interlocking means, or may comprise magnetic means for providing a magnetic connection, or a combination thereof. As shown in FIGS. 2B and 2C, the main body 200 may be provided with a magnetic coupling element 210. Additionally, the cover 300 may be provided with a magnetic counter coupling element 310. The magnetic coupling element 210 and the magnetic counter coupling element 310 may comprise a permanent magnet and a corresponding permanent magnet or ferromagnetic component, or vice versa.

Due to the shape and size of the light emitting indicator 220 being larger than the shape and size of the light-transmissive portion 300a, it is preferably to mask the portions of the light emitting indicator 220 that exceed that shape and size of the light-transmissive portion 300a when viewed from a light propagation direction of light emitted from the light emitting indicator 220 through the light-transmissive portion 300a. For this purpose, regions of the cover 300 that surround or encircle the light-transmissive portion 300a on the exterior surface of the cover 300 are configured to be opaque portions 300b. In general, this can be achieved by provided the light-transmissive portion 300a and the opaque portions 300b of the cover 300 surrounding or encircling the light-transmissive portion 300a as separate parts, each part comprising or substantially consisting of a material exhibiting different optical properties. For example, light-transmissive portion 300a may comprise or substantially consists of a at least partially transparent material such as, for example, glass, PET, PMMA, PVC, PC or any other suitable plastic material or glass material. The surrounding or encircling portions of the cover 300 may comprise or substantially consist of an opaque material such as, for example, opaque and/or colored plastic materials or a metal material.

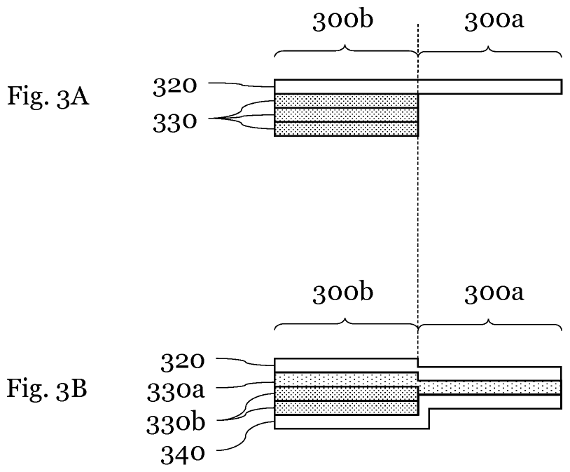

As shown in FIGS. 3A and 3B, it is preferably to provide a cover 300 comprising or substantially consisting of a composite laminar structure that includes a plurality of different layers. Different layers of the composite laminar structure may be provided in different sizes or shapes, i.e. a layer of the composite laminar structure may have a size and shape corresponding to the size and shape of the cover 300, or may have a size or shape different from the size of the cover 300 and thus be provided in only a portion of the cover 300. Additionally, or alternatively, different layers may be provided with different mechanical and/or optical properties. As shown FIG. 3A, each layer of the plurality of layer has an upper surface that corresponds to an outer surface and a lower surface that corresponds to an inner surface of the layer. The composite laminar structure comprises an uppermost layer 320 that is a light-transmissive layer. The light-transmissive layer may be a fully transparent layer or a translucent layer. Different portions of the cover 300 and hence of the composite laminar structure may comprise different types and/or different amounts of layers. As shown in FIG. 3A, the light-transmissive portion 300a of the cover 300 comprises only the uppermost layer 320. Hence, any mechanical and optical properties of the light-transmissive portion 300a are largely defined by the mechanical and optical properties of the uppermost layer 320. In a preferred embodiment, the uppermost layer 320 comprises or substantially consists of a light-transmissive plastic film layer.

The uppermost layer 320 may be provided on its lower surface with one or more at least partially or fully opaque layers 330. The at least partially or fully opaque layers 330 may serve the function of providing optical and/or mechanical properties to the light-transmissive portion 300a that are different optical and/or mechanical properties of the surrounding or encircling opaque portion 300b of the cover 300b. For example, as shown in FIG. 3A, the light-transmissive portion 300a is not provided with any at least partially or fully opaque layers 330, and hence, any optical and/or mechanical properties of the light-transmissive portion 300a are provided by the uppermost layer 320. The opaque portion 330b is provided with one or more at least partially or fully 3, opaque layers 330 such that the combination of the uppermost layer 320 and the one or more at least partially or fully opaque layers form a portion of the cover 300 that is opaque. Alternatively, as shown in FIG. 3B, the uppermost layer 320 is provided with one or more partially opaque layers 330a that are comprised in both the light-transmissive portion 300a as well as the surrounding or encircling opaque portion 300b of the cover 300. For example, the uppermost layer 320 may be a fully transparent layer, and the one or more partially opaque layers 330a provided at the lower surface of the uppermost layer 320 at the light-transmissive portion 300a are configured to render the light-transmissive portion 300a translucent to increase the homogeneity of the illumination of the light-transmissive portion 300a. For the opaque portion 330b, the lowermost layer of the one or more partially opaque layers 330a may be further provided on its lower surface with one or more at least partially or fully opaque layers 330b to render the opaque portion 300b of the cover 300b opaque such that no light can be transmitted through the opaque portion 300b. The lowermost layer of the one or more at least partially or fully opaque layers 330b of the opaque portion 300b of the cover 300, and the lowermost layer of the one or more partially opaque layers 330a of the light-transmissive portion 300a may be provided on their respective lower surface with a common substrate layer 340. The substrate layer 340 may be a transparent or translucent substrate layer that is configured to provide mechanical support to the composite laminar structure of the cover 300. The substrate layer 340 may comprise or substantially consist of a plastic material comprising a thermoplastic or thermosetting material. The plurality of at least partially opaque layers 330a and/or the plurality of at least partially or fully opaque layers 330b may thus be interposed between the uppermost layer 320 and the substrate layer 340.

Furthermore, the upper surface of the light-transmissive portion 300a may not be flush with the upper surface of the surrounding or encircling opaque portion 300b of the cover 300, but may be configured to be recessed from the upper surface of the opaque portion 300b. Alternatively, the light-transmissive portion 300a may be configured to protrude from the upper surface of the opaque portion 300b. The upper surface of the light-transmissive portion 300a itself may flat or curved. Additionally, or alternatively, the upper surface of the light-transmissive portion may be provided with protrusions or grooves that may serve functional or decorative purposes. It should further be noted that layers show in FIGS. 3A and 3B may be interchanged or combined. For example, the composite laminar structure shown in FIG. 3A may further be provided with a substrate layer. The upper surface of the light-transmissive portion 300a may be provided as described in the context of FIG. 3B. As another example, the positioning of the partially opaque layers 330a and the at least partially or fully opaque layers may be arranged in different layering orders.

In a preferred embodiment, the cover 300 is manufactured using a film insert moulding (FIM) process. In this process, first, a decorated plastic film or sheet may be decorated, and is subsequently shaped and trimmed according to specification. In a next step, the thus processed plastic film or sheet is inserted into an injection mould and is back injected on its inner (back) surface with a thermoplastic resin. Alternatively, the plastic film or sheet may also be overmoulded with a thermoplastic resin. The plastic film or sheet may be decorated via grooves or protrusions as functional or decorative embellishments via the injection mould. Additionally, or alternatively, the plastic film or sheet may be decorated by applying one or more printed layers on the inner (back) surface of the plastic film or sheet. Referring to embodiments described in the context of FIGS. 3A and 3B, the plastic film or sheet corresponds to the uppermost layer 320. The one or more at least partially layers 330a and the one or more at least partially or fully opaque layer 330b correspond to printed layers applied to the inner surface of the uppermost layer 320. The back-injected thermosetting resin corresponds to the substrate layer 340.

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the scope of this disclosure, as defined by the independent and dependent claims.

### LIST OF REFERENCE SIGNS USED

100 aerosol generation device
110 consumable
200 main body with main housing
210 main body attaching means
220 light-emitting indicator
221 light source
300 cover
300a light-transmissive portion of the cover
300b opaque portion of the cover
310 cover attaching means
320 transparent layer
330/330a/330b partially or fully opaque layer
340 substrate layer

1. An aerosol generation device comprising:
a main body with a main housing that forms the exterior surface of the main body, the main body configured for generating an aerosol from an aerosol generation substrate and comprising a light-emitting indicator; and
a cover that is releasably attached or connected to the main housing to cover a portion of the exterior surface of the main housing and to form part of the exterior surface of the aerosol generation device, the cover comprising a light-transmissive portion;
wherein the light-emitting indicator is configured to emit light through the light-transmissive portion in a light propagation direction through the light-transmissive portion,
wherein the projection of the light-emitting indicator onto a plane which is transversal to the light propagation direction has a first shape and size, and the projection of the light-transmissive portion onto this plane has a second shape and size, and
wherein the second size is smaller than the first size and the second shape fully fits into the first shape.

2. The aerosol generation device according to claim 1, wherein the light-emitting indicator is a light source.

3. The aerosol generation device according to claim 1, wherein the light-emitting indicator and the light-transmissive portion are aligned relative to each other such that light emitted from the light-emitting indicator in the light propagation direction illuminates substantially the entire light-transmissive portion.

4. The aerosol generation device according to claim 1, wherein the light propagation direction is substantially perpendicular to the exterior surface of the light-transmissive portion.

5. The aerosol generation device according to claim 1, wherein the light-emitting indicator has an elongated shape with a length that corresponds to the extension of the light-emitting indicator in the elongation direction, and a width that corresponds to the extension of the light-emitting indicator in the direction perpendicular to the elongation direction, and perpendicular to the light propagation direction, and
wherein the light-transmissive portion has a length which is smaller than the length of the light-emitting indicator, and a width which is smaller than the width of the light-emitting indicator.

6. The aerosol generation device according to claim 1, wherein a portion or all of the cover surrounding or encircling the light-transmissive portion is opaque.

7. The aerosol generation device according to claim 1, wherein the cover comprises a composite laminar structure comprising a plurality of layers, each layer having an outer surface facing towards an outside of the aerosol generation device, and an inner surface facing towards the main housing.

8. The aerosol generation device according to claim 7, wherein the plurality of layers comprises a light-transmissive plastic film layer.

9. The aerosol generation device according to claim 8, wherein the light-transmissive portion comprises at least a portion of the light-transmissive plastic film layer.

10. The aerosol generation device according to claim 8, wherein the transparent plastic film is provided on an inner surface thereof with one or more at least partially or fully opaque layers.

11. The aerosol generation device according to preceding claim 10, wherein the light-transmissive portion comprises a number of partially opaque layers that is less than the number of at least partially and/or fully opaque layers comprised by portions of the cover that are opaque.

12. The aerosol generation device according to claim 10, wherein the light-transmissive portion does not comprise a partially opaque layer.

13. The aerosol generation device according to claim 10, wherein the one or more at least partially or fully opaque layers are interposed between the transparent plastic film and a support layer.

14. The aerosol generation device according to claim 10, wherein the one or more at least partially or fully opaque layers comprise one or more printed layers.

15. The aerosol generation device according to claim 1, wherein the cover is film insert molded (FIM).

16. The aerosol generation device according to claim 9, wherein the transparent plastic film is provided on an inner surface thereof with one or more at least partially or fully opaque layers.

17. The aerosol generation device according to claim 16, wherein the light-transmissive portion comprises a number of partially opaque layers that is less than the number of at least partially and/or fully opaque layers comprised by portions of the cover that are opaque.

18. The aerosol generation device according to claim 11, wherein the light-transmissive portion does not comprise a partially opaque layer.

19. The aerosol generation device according to claim 11, wherein the one or more at least partially or fully opaque layers are interposed between the transparent plastic film and a support layer.

20. The aerosol generation device according to claim 11, wherein the one or more at least partially or fully opaque layers comprise one or more printed layers.
